(19) United States
(12) Patent Application Publication
(10) Pub. No.: US 2024/0004961 A1
(43) Pub. Date: Jan. 4, 2024

(54) DETERMINING ENVIRONMENTAL ACTOR IMPORTANCE WITH ORDERED RANKING LOSS

(71) Applicant: GM Cruise Holdings LLC, San Francisco, CA (US)

(72) Inventors: Chingiz Bagatur ogly Tairbekov, San Francisco, CA (US); Logan Jared Perreault, Billings, MT (US)

(73) Assignee: GM Cruise Holdings LLC, San Francisco, CA (US)

(21) Appl. No.: 17/855,729

(22) Filed: Jun. 30, 2022

(51) Int. Cl. G06K 9/62

(52) U.S. Cl. CPC G06K 9/6263; G06K 9/6256; G06K 9/6252

(57) ABSTRACT

An actor importance model predicts an actor importance ranking of actors in the environment of an autonomous vehicle (AV). The actors represent detected objects in the environment that may be relevant to perception and planning of the AV. To direct resources of the AV, the actors are ranked in the relative importance to the AV's intent in navigating the environment. The actor importance model may generate embeddings to represent the actors, AV intent, and the overall scene. To train the model, a relative ordering loss may be used that evaluates the relative ordering of the actors with respect to one another, which may be further modified based on a threshold for which further processes are affected by the ranking.

### BACKGROUND

### 1. Technical Field

This disclosure relates generally to environmental perception, and more particularly to automated determination of relative importance of actors in the environment.

### 2. Introduction

Various systems, such as autonomous vehicles (AVs) may sense objects in an environment based on various sensor data. Such systems may include various computing components for locally determining and responding to aspects of the environment. For example, the AV may detect objects in the environment, particularly moving objects, and control navigation of the AV based on the detected objects. The computing components on the AV are generally resource and time-constrained, such that the AV may apply a limited amount of processing each “tick” for detecting objects and modifying its intended navigation in the environment. Meanwhile, different types of environments vary in complexity and may vary with different numbers and types of objects that may have various movement characteristics in the environment. The processing and other resource capacity of the AV may mean that it cannot fully assess all the detected objects in the environment (also termed “actors”) within a specified time period, also termed a “tick.” To focus resource usage of the AV (or another system evaluating the environment), the AV may benefit from improved approaches for ranking the relative importance of the actors in the environment so that resources may be effectively directed to actors of higher importance and relatively lower importance actors may be deprioritized.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example system environment that can be used to facilitate autonomous vehicle (AV) dispatch and operations, according to some aspects of the disclosed technology;

FIG. 2 illustrates an example of a deep learning neural network that can be used to implement a perception module and/or one or more validation modules, according to some aspects of the disclosed technology;

FIG. 3 illustrates an example processor-based system with which some aspects of the subject technology can be implemented;

FIG. 4 illustrates an example environment including an AV and various detected actors within the environment, according to one embodiment;

FIG. 5 shows an example data flow for an actor importance model, according to one embodiment;

FIG. 6 shows an example architecture for the actor importance model, according to one embodiment;

FIGS. 7A-7C show example embodiments for determining distance estimates for each actor, according to one embodiment; and

FIG. 8 shows an example of a loss function for an example training data instance, according to one embodiment.

### DETAILED DESCRIPTION

### Overview

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

To improve use of the AV's limited computing resources, an object importance model may be trained to generate a ranked list of the actors perceived within an environment. An “actor” is a detected object within the environment separate from background elements of the environment (i.e., stationary features of the environment, such as buildings, roads, fences, etc.). Actors thus include objects that may move (or are currently moving) within the environment. To determine the relative importance of the various actors in the environment, the AV may apply an actor importance model that ranks the detected actors in the environment. The ranked actors may then be used to affect how the actors are further processed for further perception, planning, or other tasks by the AV. The actor importance model may be a relatively “lightweight” computer model, including neural network layers and other components, for determining the relative importance of the actors within the available resources for a “tick” of a perception stack of the AV while allowing further processing within the tick based on the rankings. As such, the actor importance model may be considered to guide, filter, or direct which actors receive further processing and evaluation based on the relative importance.

In one embodiment, the actor importance model characterizes each actor in a set of actors with a set of actor features, which may include the position of the actor and the relative distance of the actor with respect to the expected AV movement (e.g., the AV's intent) at one or more times. The AV intent may be similarly characterized to describe the planned movement of the AV across one or more times. The actor and AV intents may be used in the actor importance model to generate a representation of the scene (e.g., a scene embedding) describing the overall expected movement of the AV and the overall set of actors.

To determine the ranking of the individual actors, the actor features may be evaluated with respect to the scene representation to determine scores for each actor with respect to the scene, which may then be ordered to determine the ranking. In one embodiment, the scene is represented as a scene embedding and each actor is represented by a respective actor embedding. In one embodiment, the actor importance model includes various models for characterizing the actors and scene as embeddings. These models may be multi-layer perceptrons (MLPs) and generate embeddings for respectively representing the actors, AV intent, and scene. In one embodiment, as the number of actors in the scene is variable, a joint actor embedding is determined based on the actor embeddings and in one example is a sum of the actor embeddings. Then, in one embodiment, the scene embedding is determined from the joint actor embedding and the AV embedding (characterizing the AV intent). The joint actor embedding (formed from the actor embeddings) may thus allow the scene embedding to characterize the AV intent in combination with any number of actors detected in the scene.

To train parameters of the actor importance model, the training loss may be determined based on the predicted ranking of the actor importance model relative to a training ranking of the actors for a set of training data. Because the number of actors in a particular scene may vary, the training loss may be based on the relative ordering of actors in the predicted ranking compared to the training ranking. As such, the parameters may learn whether actors were ranked correctly relative to one another, rather than relative to an absolute order, which may significantly differ when there are different numbers of actors in the training data. In one embodiment, the error is based on a pairwise comparison of whether the relative ordering of actors (e.g., a pair of actors including a first actor and second actor) was correctly ranked in the predicted ranking compared to the training ranking. In one embodiment, the final error is a symmetric linear combination of pairwise errors. The error may also be a sum of the pairwise errors.

As another example, the training loss may also be based on a threshold, such that the training loss may discount or disregard an error cost based on an actor's ranking relative to the threshold. In some embodiments, the threshold may be based, e.g., on resources of the computing device and further processing of the AV perception stack. For example, in some examples the perception stack may be capable of executing further object detection and/or movement prediction for up to 10 actors, such that the training loss threshold may be set at the ranking of 10 to prioritize errors around the value at which further processing may be required or discarded and to discard errors for error below the threshold. That is, the error attributable to actors below the threshold may be reduced or eliminated to focus training on the actors above the threshold. Similarly, when actors are above the threshold (e.g., mis-ordered but both above the threshold), the training error for these actors may be reduced to encourage training parameters to focus on the errors around the threshold. By applying a relative error and, optionally, focusing error with respect to a threshold, the actor importance model may learn to generate rankings for a dynamic number of actors and focus its parameters on the rankings which may be most important for downstream decisions.

### System Overview

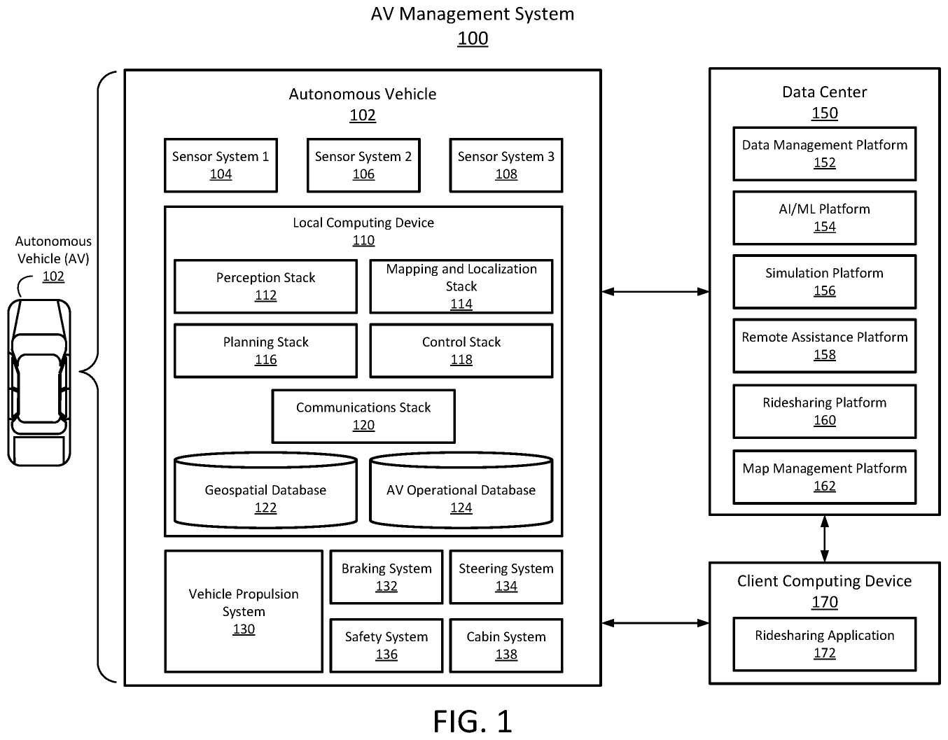

FIG. 1 illustrates an example of an AV management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 102 can navigate about roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), light sensors (e.g., LIDAR systems, ambient light sensors, infrared sensors, etc.), RADAR systems, a Global Navigation Satellite System (GNSS) receiver (e.g., Global Positioning System (GPS) receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors.

AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, a wheel braking system (e.g., a disc braking system that utilizes brake pads), hydraulics, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some embodiments, the AV 102 may not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV 102's environment; logging metrics collected by the sensor systems 104-108; and so forth. In this example, the local computing device 110 includes a perception stack 112, a mapping and localization stack 114, a planning stack 116, a control stack 118, a communications stack 120, a geospatial database 122, and an AV operational database 124, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the geospatial database 122, other components of the AV 102, and other data sources (e.g., the data center 150, the client computing device 170, third-party data sources, etc.). The perception stack 112 can detect and classify objects and determine their current and predicted locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth.

The mapping and localization stack 114 can determine the AV's position and orientation (pose) using different methods from multiple systems (e.g., GPS, IMUs, cameras, LIDAR, RADAR, ultrasonic sensors, the geospatial database 122, etc.). For example, in some embodiments, the AV 102 can compare sensor data captured in real-time by the sensor systems 104-108 to data in the geospatial database 122 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The planning stack 116 can determine how to maneuver or operate the AV 102 safely and efficiently in its environment. For example, the planning stack 116 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, Double-Parked Vehicles (DPVs), etc.), traffic rules and other safety standards or practices for the road, user input, and other relevant data for directing the AV 102 from one point to another. The planning stack 116 can determine multiple sets of one or more mechanical operations that the AV 102 can perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 116 can select from multiple backup plans to carry out. For example, while preparing to change lanes to turn right at an intersection, another vehicle may aggressively cut into the destination lane, making the lane change unsafe. The planning stack 116 could have already determined an alternative plan for such an event, and upon its occurrence, help to direct the AV 102 to go around the block instead of blocking a current lane while waiting for an opening to change lanes.

The control stack 118 can manage the operation of the vehicle propulsion system 130, the braking system 132, the steering system 134, the safety system 136, and the cabin system 138. The control stack 118 can receive sensor signals from the sensor systems 104-108 as well as communicate with other stacks or components of the local computing device 110 or a remote system (e.g., the data center 150) to effectuate operation of the AV 102. For example, the control stack 118 can implement the final path or actions from the multiple paths or actions provided by the planning stack 116. This can involve turning the routes and decisions from the planning stack 116 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI® network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), BLUETOOTH®, infrared, etc.).

The geospatial database 122 can store maps and related data of the streets upon which the AV 102 travels. The data stored in the geospatial database 122 may describe spatial information at a relatively “high” resolution (e.g., with “high-definition” (HD) mapping data) relative to the perception and size of components of the AV 102. In some embodiments, the maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane or road centerline, lane boundaries, type of lane boundaries, etc.) and related attributes (e.g., direction of travel, speed limit, lane type, etc.). The lanes and boundaries layer can also include 3D (three-dimensional) attributes related to lanes (e.g., slope, elevation, curvature, etc.). The intersections layer can include geospatial information of intersections (e.g., crosswalks, stop lines, turning lane centerlines, and/or boundaries, etc.) and related attributes (e.g., permissive, protected/permissive, or protected only left turn lanes; permissive, protected/permissive, or protected only U-turn lanes; permissive or protected only right turn lanes; etc.). The traffic controls layer can include geospatial information of traffic signal lights, traffic signs, and other road objects and related attributes.

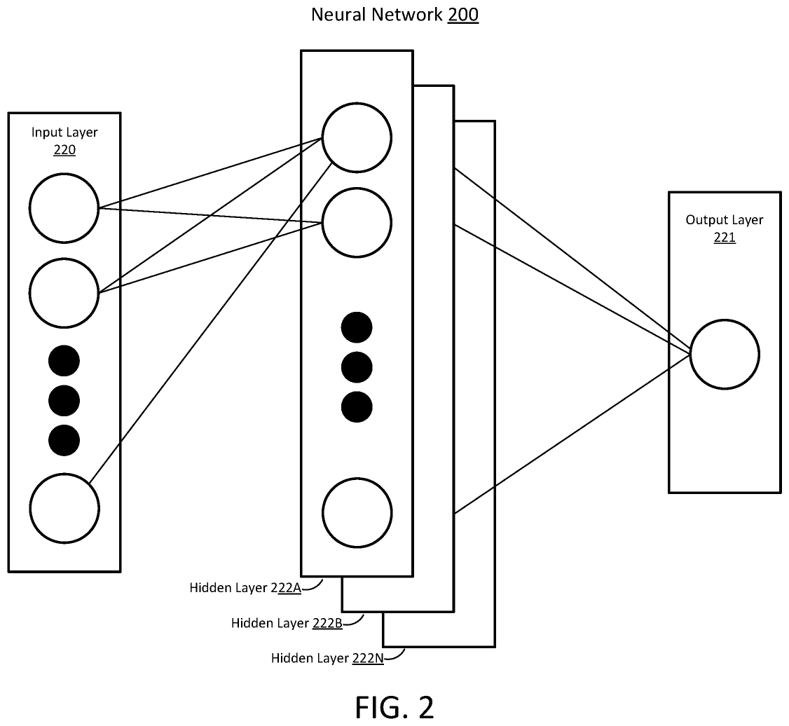

The AV operational database 124 can store raw AV data generated by the sensor systems 104-108 and other components of the AV 102 and/or data received by the AV 102 from remote systems (e.g., the data center 150, the client computing device 170, etc.). In some embodiments, the raw AV data can include LIDAR point cloud data, image or video data, RADAR data, GPS data, and other sensor data that the data center 150 can use for creating or updating AV geospatial data as discussed further below with respect to FIG. 2 and elsewhere in the present disclosure.

The data center 150 can be a private cloud (e.g., an enterprise network, a co-location provider network, etc.), a public cloud (e.g., an IaaS network, a PaaS network, a SaaS network, or other CSP network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes one or more of a data management platform 152, an Artificial Intelligence/Machine-Learning (AI/ML) platform 154, a simulation platform 156, a remote assistance platform 158, a ridesharing platform 160, and a map management platform 162, among other systems.

The data management platform 152 can be a “big data” system capable of receiving and transmitting data at high speeds (e.g., near real-time or real-time), processing a large variety of data, and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine-learning algorithms for operating the AV 102, the simulation platform 156, the remote assistance platform 158, the ridesharing platform 160, the map management platform 162, and other platforms and systems. Using the AI/ML platform 154, data scientists can prepare data sets from the data management platform 152; select, design, and train machine-learning models; evaluate, refine, and deploy the models; maintain, monitor, and retrain the models; and so on.

The simulation platform 156 can enable testing and validation of the algorithms, machine-learning models, neural networks, and other development efforts for the AV 102, the remote assistance platform 158, the ridesharing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the map management platform 162; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, a smart wearable device (e.g., smart watch; smart eyeglasses or other Head-Mounted Display (HMD); smart ear pods or other smart in-ear, on-ear, or over-ear device; etc.), gaming system, or other general purpose computing device for accessing the ridesharing application 172. The client computing device 170 can be a customer's mobile computing device or a computing device integrated with the AV 102 (e.g., the local computing device 110). The ridesharing platform 160 can receive requests to be picked up or dropped off from the ridesharing application 172 and dispatch the AV 102 for the trip.

The map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 402, Unmanned Aerial Vehicles (UAVs), satellites, third-party mapping services, and other sources of geospatially-referenced data. The raw data can be processed, and map management platform 162 can render base representations (e.g., tiles (2D), bounding volumes (3D), etc.) of the AV geospatial data to enable users to view, query, label, edit, and otherwise interact with the data. The map management platform 162 can manage workflows and tasks for operating on the AV geospatial data. The map management platform 162 can control access to the AV geospatial data, including granting or limiting access to the AV geospatial data based on user-based, role-based, group-based, task-based, and other attribute-based access control mechanisms. The map management platform 162 can provide version control for the AV geospatial data, such as to track specific changes that (human or machine) map editors have made to the data and to revert changes when necessary. The map management platform 162 can administer release management of the AV geospatial data, including distributing suitable iterations of the data to different users, computing devices, AVs, and other consumers of HD maps. The map management platform 162 can provide analytics regarding the AV geospatial data and related data, such as to generate insights relating to the throughput and quality of mapping tasks.

In some embodiments, the map viewing services of the map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridesharing platform 160 may incorporate the map viewing services into the client computing device 170 to the ridesharing application 172 to enable passengers to view the AV 102 in transit en route to a pick-up or drop-off location, and so on.

FIG. 2 is an illustrative example of a neural network 200 that can be used to implement all or a portion of related computer models used by the AV, such as in the perception stack discussed above. An input layer 220 can be configured to receive sensor data and/or data relating to an environment surrounding an AV. The neural network 200 includes multiple hidden layers 222A, 222B, through 222N. The hidden layers 222A, 222B, through 222N include “n” number of hidden layers, where “n” is an integer greater than or equal to one. The number of hidden layers include as many layers as needed for the given application. The neural network 200 further includes an output layer 221 that provides an output resulting from the processing performed by the hidden layers 222A, 222B, through 222N.

The neural network 200 is a multi-layer neural network of interconnected nodes. Each node may represent data as it is processed from one layer to another according to parameters of the model. For example, in many types of networks, each layer is generated by applying weights to values of a prior layer and in some embodiments may be summed to generate the value for a node of a current layer. Depending on the type of neural network 200, different types of network layers may be used, such as fully-connected layers, regularization layers, recurrent layers, etc. In some embodiments, information associated with the nodes is shared among the different layers and each layer retains information as information is processed. In some cases, the neural network 200 can include a feed-forward network, in which data is fed forward through the layers from the input to output. In some cases, the neural network 200 can include recurrent elements, which can include loops that allow information to be carried across nodes while reading in input.

Information can be exchanged between nodes through node-to-node interconnections between the various layers. Nodes of the input layer 220 can activate a set of nodes in the first hidden layer 222A. For example, as shown, each of the input nodes of the input layer 220 is connected to each of the nodes of the first hidden layer 222A. The nodes of the first hidden layer 222A can transform the information of each input node by various parameters (e.g., weights, activation functions, etc.) to the input node information. The information derived from the transformation can then be passed to and can activate the nodes of the next hidden layer 222B, which can perform their own designated functions. Example functions include convolutional, up-sampling, data transformation, and/or any other suitable functions. The output of the hidden layer 222B can then activate nodes of the next hidden layer, and so on. The output of the last hidden layer 222N can activate one or more nodes of the output layer 221, which results in output of the neural network. In some cases, while nodes in the neural network 200 are shown as having multiple output lines, a node can have a single output and all lines shown as being output from a node represent the same output value.

In some cases, each node or interconnection between nodes can have a set of parameters (e.g., weights) derived from the training of the neural network 200. Once the neural network 200 is trained, it may be applied to new data and to predict an output for the new data based on the parameters learned in the training from the training data. As such, an interconnection between nodes can represent a piece of information learned about the relationship between the interconnected nodes (e.g., a parameter describing the relationship between). The interconnection can have a tunable numeric weight that can be learned (e.g., based on a training dataset), allowing the neural network 200 to be trained to output data based on the training data.

In some cases, the neural network 200 can adjust the parameters of the nodes using a training process called backpropagation. A backpropagation process can include a forward pass, a loss function, a backward pass, and a weight update. The forward pass, loss function, backward pass, and parameter/weight update is performed for each training iteration. The process can be repeated for a certain number of iterations for each set of training data until the neural network 200 is trained well enough so that the weights of the layers are accurately tuned.

To perform training, a loss function can be used to analyze error in the output. Any suitable loss function may be used to describe the “error” of the output of the neural network 200 (given its current parameters) with respect to the desired output (e.g., for a supervised training process, the known output values for the training data). Example training losses may include Cross-Entropy loss or mean squared error (MSE).

The loss (or error) will be high for the initial training data since the output values of the model will be much different than the predicted output. The goal of training is to minimize the amount of loss so that the predicted output is the same as the training output. The neural network 200 can perform a backward pass by determining which parameters most contributed to the loss of the network and adjusts weights so that the loss decreases. Various approaches may be used in training to modify the parameters, such as gradient descent.

The neural network 200 can include any suitable deep network. One example includes a Convolutional Neural Network (CNN), which includes an input layer and an output layer with multiple hidden layers between the input and out layers. The hidden layers of a CNN include a series of convolutional, nonlinear, pooling (for downsampling), and fully-connected layers. The neural network 200 can include any other deep network other than a CNN, such as fully-connected layer, MLP, an autoencoder, Deep Belief Nets (DBNs), Recurrent Neural Networks (RNNs), among others.

As understood by those of skill in the art, computer model (also described herein as machine-learning) architectures can vary depending on the desired implementation. For example, computer model architectures can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine-learning models can also use or apply various additional algorithms, such as clustering algorithms, e.g., a K-means clustering algorithm, a Min-wise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

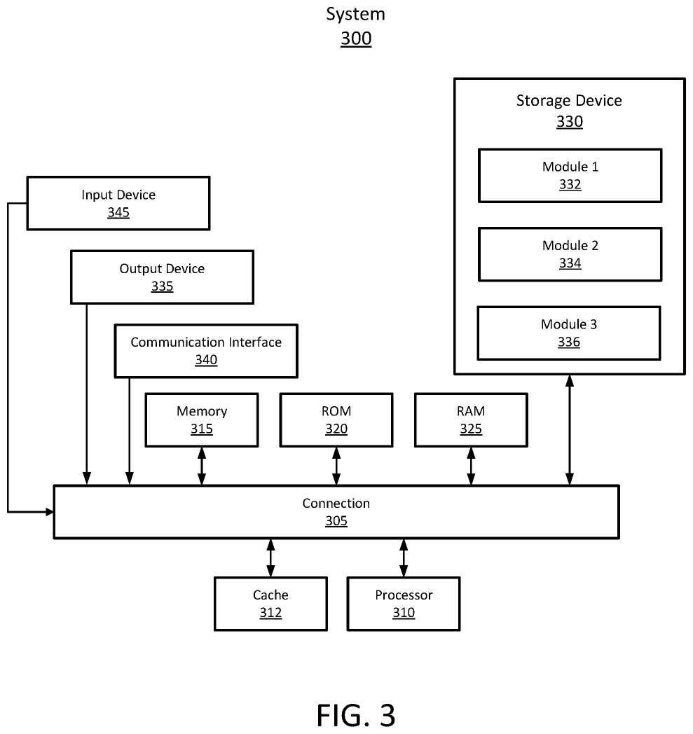

FIG. 3 illustrates an example processor-based system with which some aspects of the subject technology can be implemented. For example, a processor-based system 300 can be any computing device making up, or any component thereof in which the components of the system are in communication with each other using a connection 305. The connection 305 can be a physical connection via a bus, or a direct connection into a processor 310, such as in a chipset architecture. The connection 305 can also be a virtual connection, networked connection, or logical connection.

In some embodiments, a computing system 300 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 300 includes at least one processing unit (Central Processing Unit (CPU) or “processor”) 310 and the connection 305 that couples various system components, including system memory 315, such as Read-Only Memory (ROM) 320 and Random-Access Memory (RAM) 325 to the processor 310. The computing system 300 can include a cache of high-speed memory 312 connected directly with, in close proximity to, or integrated as part of the processor 310.

The processor 310 can include any general purpose processor and a hardware service or software service, such as service modules 332, 334, and 336 stored in storage device 330, configured to a control processor 310 as well as a special purpose processor where software instructions are incorporated into the actual processor design. The service may include one or more of the methods described herein associated with determining environmental actor importance with ordered ranking loss. The processor 310 may essentially be a completely self-contained computing system containing multiple cores or processors, a bus, memory controller, cache, etc. A multi-core processor may be symmetric or asymmetric.

To enable user interaction, the computing system 300 includes an input device 345, which can represent any number of input mechanisms, such as a microphone for speech, a touch-sensitive screen for gesture or graphical input, keyboard, mouse, motion input, speech, etc. The computing system 300 can also include an output device 335, which can be one or more of a number of output mechanisms known to those of skill in the art. In some instances, multimodal systems can enable a user to provide multiple types of input/output to communicate with the computing system 300. The computing system 300 can include a communication interface 340, which can generally govern and manage the user input and system output. The communication interface 340 may perform or facilitate the receipt and/or the transmission of wired or wireless communications via wired and/or wireless transceivers, including those making use of an audio jack/plug, a microphone jack/plug, a USB port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, WLAN signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

The communication interface 340 may also include one or more GNSS receivers or transceivers that are used to determine a location of the computing system 300 based on the receipt of one or more signals from one or more satellites associated with one or more GNSS systems. GNSS systems include, but are not limited to: the US-based GPS; the Russia-based Global Navigation Satellite System (GLONASS); the China-based BeiDou Navigation Satellite System (BDS); and the Europe-based Galileo GNSS. There is no restriction on operating on any particular hardware arrangement, and therefore the basic features here may easily be substituted for improved hardware or firmware arrangements as they are developed.

The storage device 330 can be a non-volatile and/or non-transitory and/or computer-readable memory device and can be a hard disk or other types of computer-readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid state memory, a Compact Disc (CD) Read-Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, RAM, Static RAM (SRAM), Dynamic RAM (DRAM), Read-Only Memory (ROM), Programmable ROM (PROM), Erasable PROM (EPROM), Electrically Erasable PROM (EEPROM), Flash EPROM (FLASHEPROM), cache memory (L1/L2/L3/L4/L5/L#), Resistive RAM (RRAM/ReRAM), Phase-Change Memory (PCM), Spin-Transfer Torque RAM (STT-RAM), another memory chip or cartridge, and/or a combination thereof.

The storage device 330 can include software services, servers, services, etc., that when the code that defines such software is executed by the processor 310, it causes the system 300 to perform a function. In some embodiments, a hardware service that performs a particular function can include the software component stored in a computer-readable medium in connection with the necessary hardware components, such as a processor 310, a connection 305, an output device 335, etc., to carry out the function.

### Environment Detection and Actor Importance

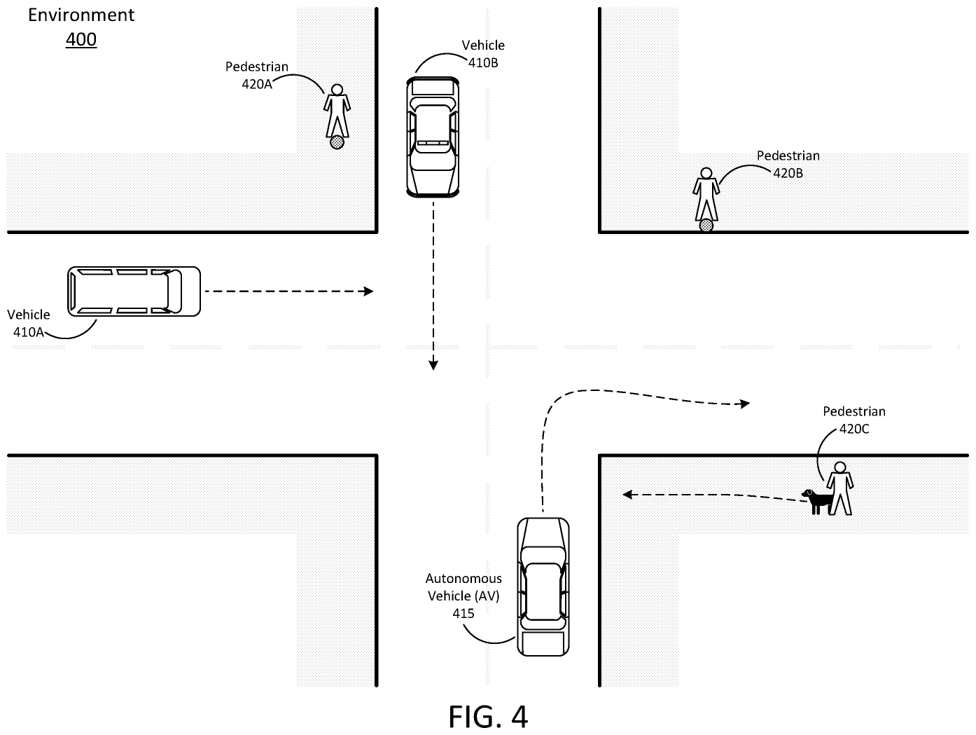

FIG. 4 illustrates an example environment 400 including an AV 415 and various detected actors within the environment 400, according to one embodiment. As shown in FIG. 4, the AV 415 may detect various actors in the environment as part of the perception stack 112 discussed in FIG. 1. These actors may include vehicles 410A-B, as well as pedestrians 420A-C. As used herein, the “actors” represent identified objects in the environment that move (or may move) and thus may warrant particular attention by the AV in further perception and planning tasks. As shown in FIG. 4, each actor may have various information detected about it by the perception stack 112. For example, each actor may have a type (e.g., a classification such as vehicle, dog, pedestrian), position, and motion (e.g., kinetic movement). The determined type may be based on a portion of the perception stack 112 that receives sensor data and identifies objects within the environment, for example by processing image, LIDAR, RADAR, and/or other sensor data based on various machine-trained models. Detected objects may also be tracked over time, such that the motion of an object across time may be used to infer current movement direction and speed. Other methods may also be used, for example, sensor data in some embodiments may directly be used to describe movement direction and/or speed without reference to previously-detected actors.

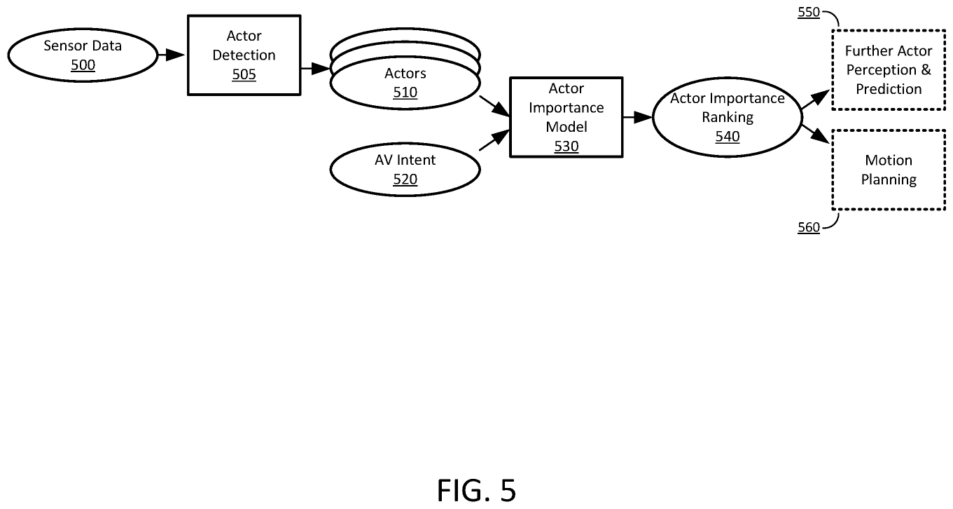

As further discussed in FIG. 5, at each “tick,” the various computing components of the AV may perceive the environment, detect objects in the environment, update its environmental map, localize the AV, and plan movement control with the various computing stacks 112-118. Each “tick” thus may have a limited amount of computational and other resources available for the local computing device 110 to perform these various actions. Given the limited computing resources, the detected actors are evaluated in one embodiment by an actor importance model to determine the relative importance of further processing information about the actors in determining additional perception and movement planning processes. In the example of FIG. 4, the detected vehicles 410A-B each have a movement towards the AV 415, while pedestrians 420A, 420B are currently stationary and pedestrian 420C is also moving towards the AV 415. In addition, FIG. 4 also illustrates the planned movement of the AV 415. The planned movement of the AV, also referred to as the “AV intent,” is the planned movement of the AV 415 from the planning stack 116. The AV intent may be generated by the prior tick of the planning stack 116 and describe the intended movement of the AV 415 in the environment at several future times. In this example, the AV 415 plans to approach the intersection, reduce its speed, and turn right at the intersection.

While environment of FIG. 4 shows some actors, in many environments the number of actors detected in the environment may be significantly higher. For example, in crowded urban environments the AV may detect dozens or even hundreds of actors. Given the limited computing resources and limited time for processing sensor data into movement controls, the relative importance of the actors may be determined (e.g., as a ranking) and used to guide further analysis.

FIG. 5 shows an example data flow for an actor importance model 530, according to one embodiment. The actor importance model 530 predicts the importance of detected actors within the environment, such as the environment shown in FIG. 4. Initially, sensor data 500 may be captured by the various sensor systems, such as sensor systems 104-108 shown in FIG. 1. The various sensor data 500 may then be processed by the perception stack 112, part of which may include actor detection 505 that identifies a set of actors 510 in the environment. The actors may be detected, for example, with object detection and/or classification models, which may identify the location of an actor within the environment (based on the sensor data) and may also determine a classification/type of the actor. The object detection may include any suitable approach, and typically includes a trained computer model such as a CNN. The number of actors detected in the environment may vary according to the environment and its complexity, and may include, for example, a few actors in relatively simple environments, and may include dozens or hundreds in more complex environments. To determine the relative importance of the actors 510, the actor importance model 530 may receive information about the actors 510 as well as the AV intent 520 to generate an actor importance ranking 540. The actor importance ranking 540 is a ranking of the actors detected in the environment, which may be a list of the actors and an associated ranking.

The actor importance ranking 540 may then be used for further actor perception & prediction 550 or as an input to motion planning 560 in various embodiments. In various embodiments, different or additional types of further processing may use the actor importance ranking 540 output from the actor importance model 530. Each of these further processes, which may be components of the perception stack 112 or the planning stack 116, may be comparatively heavier-weight processes that may benefit from the relative ranking provided by the actor importance ranking 540. For example, further actor perception and prediction 550 may include movement and intention predictions for actors within the environment, for example, to predict whether a car or pedestrian is likely change speed or direction within the environment. Such prediction algorithms may be relatively resource “heavy” with respect to computing resources available within a tick, such that these further predictions may be performed up to a maximum specified number of actors in the tick. The further predictions and actor ranking may also be provided to the motion planning 560. The motion planning 560 may use information about the environment and importance of the actors in determining further movement of the AV. As with the further perception, motion planning 560 may be relatively resource-intensive, and in some embodiments may be limited in the number of actors that may be evaluated with more extensive processes.

Though one AV intent is shown here, in other embodiments the actor importance model 530 may be executed on the set of actors 510 with multiple alternative AV intents 520. That is, while the actors 510 may be detected in the current tick, the particular actor importance ranking 540 of those actors 510 may be a function of a particular AV intent 520, which may be determined in a prior tick of the motion planning stack and include more than one AV intents, e.g., to account for alternative actual environment conditions (e.g., actor movement). In some embodiments, thus, the actor importance model 530 is applied to the actors 510 for each of the possible AV intents 520, such that an actor importance ranking 540 may be generated for each of the AV intents 520. In some instances, this may yield different rankings for various actors, which may affect which actor's likely motion is further predicted, for example to predict the motion of actors that are important to any of the possible AV intents. In one embodiment, the different actor importance rankings (associated with the different AV intents) may be provided to the different systems for further evaluation, which may use the different rankings to determine which actors to further process. In another example, the actor rankings associated with the different AV intents may be combined or weighted to determine a joint actor ranking associated with the group of different AV intents. The joint actor ranking may be determined by combining the respective actor rankings in any suitable way. For example, the joint actor ranking may be an average of the actor rankings or may be weighed along various dimensions, such as according to rank within the list (e.g., higher importance ranks may be associated with higher weights in a scalar or non-scalar manner), weighed according to a weight of the respective AV intents (e.g., based on a likelihood or priority of the respective AV intent), and/or with additional means.

As a result, the actor importance model may be valuable for evaluating the importance of detected actors with respect to one or more AV intents, permitting further analysis and processing based on the importance rankings. Example architectures and processes for embodiments are further discussed in the following FIGS.

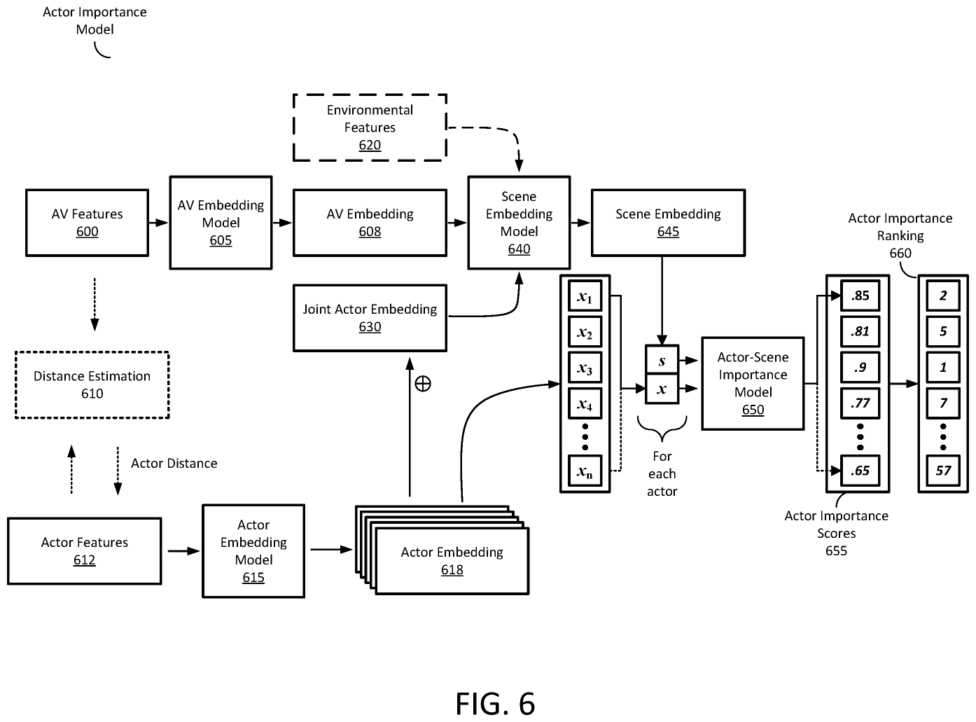

FIG. 6 shows an example architecture for the actor importance model, according to one embodiment. In this example embodiment, the actor importance model describes the AV intent as a set of AV features 600 and the actors with a set of actor features 612. In the example of FIG. 6, the actor importance model further processes the AV intent and actors to generate various types of embeddings, which may include an AV embedding 608, a set of actor embeddings 618, a joint actor embedding 630, and a scene embedding 645. Each of the embeddings describes respective information as a compact representation (e.g., a vector of values in a latent space) based on learned parameters of the respective models used for generating the embeddings. The dimensionality of the embeddings (e.g., the length of the vector, each index of which may represent an individual “dimension”) may vary in different embodiments, and may include 20, 50, 100, 200, or more values characterizing the respective concept.

The AV features 600 refers to the data describing the AV intent and the actor features 612 refer to the data describing the various actors for use in the actor importance model. In one embodiment, the AV features 600 and actor features 612 may include information describing a sequence of times projected into the future from the current time. The projected times may allow the actor importance model to represent not only current positions (of objects in the environment, such as the AV and actors), but also potential positions in the future (e.g., as actors may get closer to or further away from the AV). The AV features 600 may describe the AV intent with respect to the sequence of times, which may be designated T₀, T₁, T₂, etc. The sequence of times may begin with an initial time (e.g., T₀, or the current time), and include one or more times projected into the future. For example, T₁ may refer to the next tick of the perception/control stack. The amount of time between each of the times may vary in different embodiments, and may be a constant time (e.g., 2 seconds between each time in the sequence), or may be spaced at different or increasing intervals (e.g., 2 seconds between T₀ and T₁, 4 seconds between T₁ and T₂, 8 seconds between T₂ and T₃, etc.). In one embodiment, the sequence of times or total amount of time is the same as the forward-looking planning horizon for which the AV intent is generated (e.g., by the planning stack).

As such, in one embodiment, the AV features 600 describe the AV intent as a sequence of positions intended for the AV to move to at each of the respective sequence of times. The AV features 600 may also include additional information, such as intended speed or other motion at each of the times. In one embodiment, the AV features 600 include a set of features at each of the times in the sequence of times. For example, each time T₀, T₁, T₂, etc. may be associated with an intended position of the AV at the time according to the AV intent. Formally, the AV features 600 in one embodiment are described by a tensor having dimensions T×A, in which T is the number of times in the sequence and A is the set of AV intent features for each time.

The actor features 612 may similarly include features describing each of the actors detected in the environment. The actor features 612 may include a set of characteristics for the actors, such as a position, kinematics (e.g., speed and movement direction), and a type. The position may describe the position of the detected actor expected for each time and may vary at each time based on, e.g., the motion information of a previous time. The kinematics may describe movement of the actor in various ways. In one example, the actor's kinematic information may be based on the detected movement in the current tick or may be based on information predicted from a previous tick of the perception stack, which may, for example, describe a more complex expected movement trajectory for the actor. For example, in a previous tick, the perception stack may predict that an approaching car to an intersection is expected to slow and stop because the car approaches along a path that has a stop sign or stop light. In some embodiments, the position and kinematics may be determined for further times past the current time (e.g., past T₀) by “unrolling” the actor's position and velocity at one time to project the expected position at a subsequent time (e.g., position_{T}_{₁}=position_{T}_{₀}+kinematics_{T}_{₀}). As such, in one example, when no prior trajectory is predicted for an actor (e.g., by a prior tick), features describing the position for the actor across time may be generated with relatively low computational requirements.

The actor features may also include a classification of the actor as determined by a perception model (e.g., a classification model). The classification may describe, for example, that the actor is a vehicle, a heavy vehicle, a pedestrian, an animal, etc. In some embodiments, the classification of the actors may be performed by a relatively “lightweight” classification model (e.g., for actors which are not tracked across ticks or for which more detailed classification has been performed). That is, because one purpose of the actor importance ranking is to prioritize the application of resources for further perception, in one embodiment the classification of actors used as an input to the actor ranking model may be relatively course or “low-granularity” classifications that may describe types of objects at a high-level. For example, humans may all be identified as the class “person”—when a particular actor having the class “person” is determined as having a high actor importance, in one embodiment, additional perception models may be applied to determine a further subtype of the “person” class and the likely behavior for that person for further AV motion planning. For example, the sensor data related to the detected person may then be analyzed by a further model that may distinguish between adults, children, walkers, runners, joggers, and so forth, to determine potential intent or movement of that “person” object. For a “person” object which are relatively low rank in importance (for example, farther away from the AV and having movement away from the AV's trajectory), this “person” object may not be considered sufficiently important for further perception processing.

As the number of actors identified in the environment may be variable depending on whether the AV is in a relatively crowded or sparse environment, the actor features 612 may include features for each of the actors N for each of the times T. As such, the actor features 612 may be described as a tensor of N×T×E, where E are the features (e.g., position, kinematics, and type) at each of T times for each actor N. In some embodiments, some actor features may not vary across time (e.g., detected actor type), such that the T dimension describes only features that vary across time (e.g., position and/or kinematics). In other embodiments, the structure of the models consuming the actor features 612 may be more effective or efficient when receiving a tensor in which the actor features are organized by each point in time and the features that do not vary across time are repeated as a “feature” of each point in time.

In one embodiment, the actor features 612 also include an estimated distance between the AV at the various points in time. That is, as the AV intent and actor positions may be “unrolled” to the future times, the expected distance between the AV and the actors at the future times may be estimated and used as one feature describing each actor. As such, the actor feature tensor may be expanded to N×T×(E+1) in some embodiments. Because AV planning is typically more likely to be affected by objects nearer to the AV including features that describe the predicted distance between the actor and the AV (at each of the various points in time T₀-Tₘ), the actor importance model may more directly incorporate this feature in predicting the actor importance.

While distance is one example, further features used for generating the actor embedding may be generated as a function of the actor features and the AV intent features. Formally, these features may be a function ƒ(N(t), A(t)) of actor features N and AV intent features A at a time t. Generally, these features may be used to provide values that may vary across time and may provide a notion of “attention” indicating differences in time for which the actor may be more or less relevant.

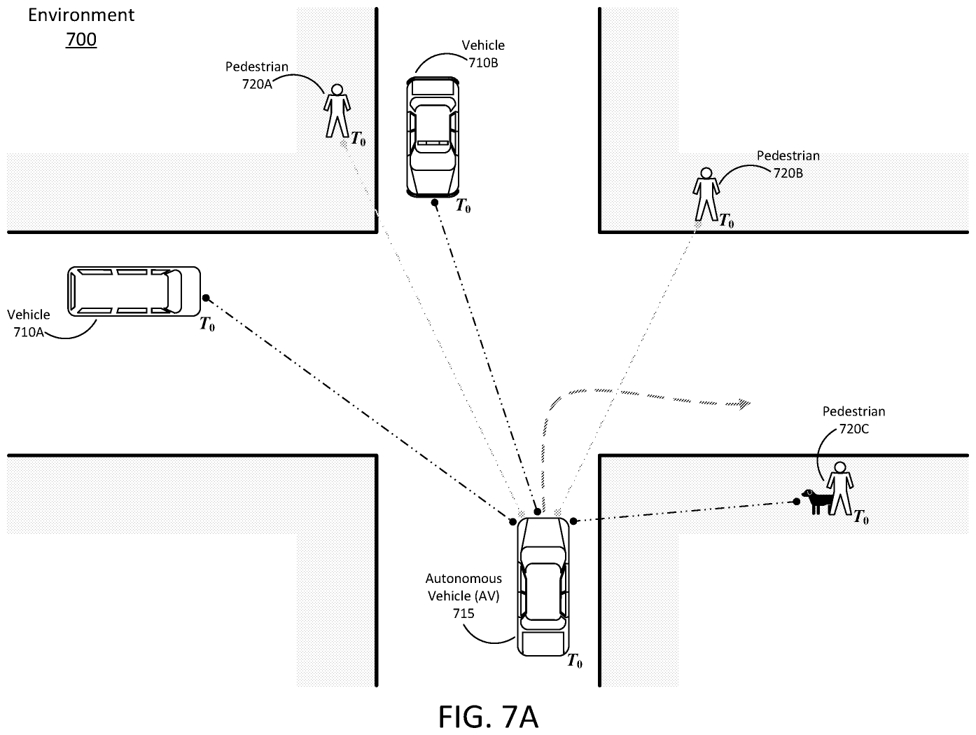

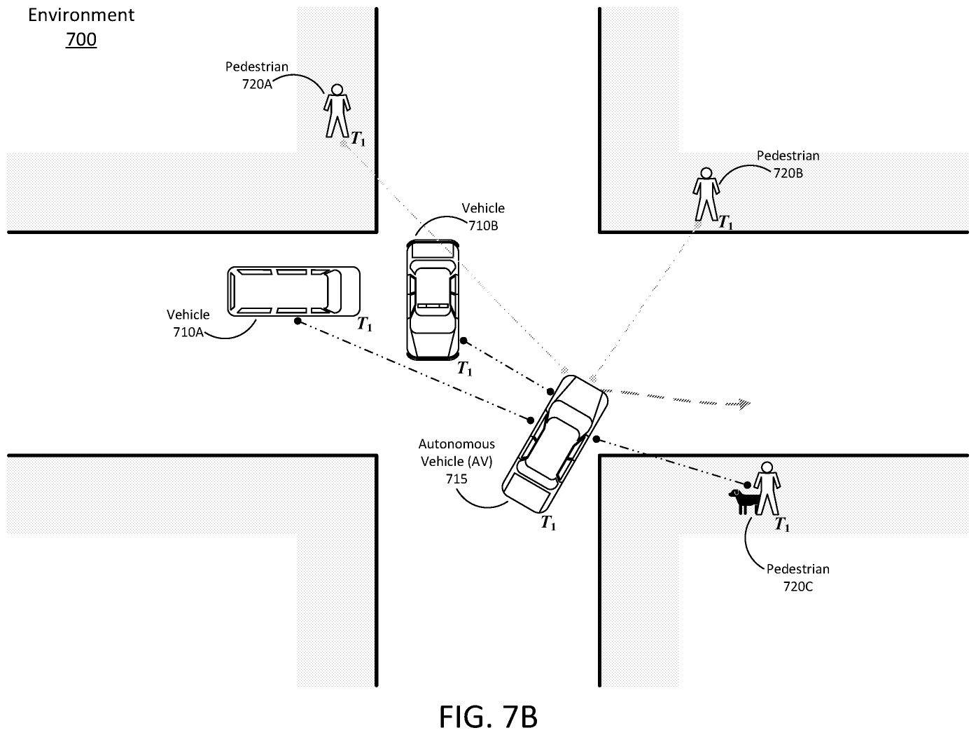

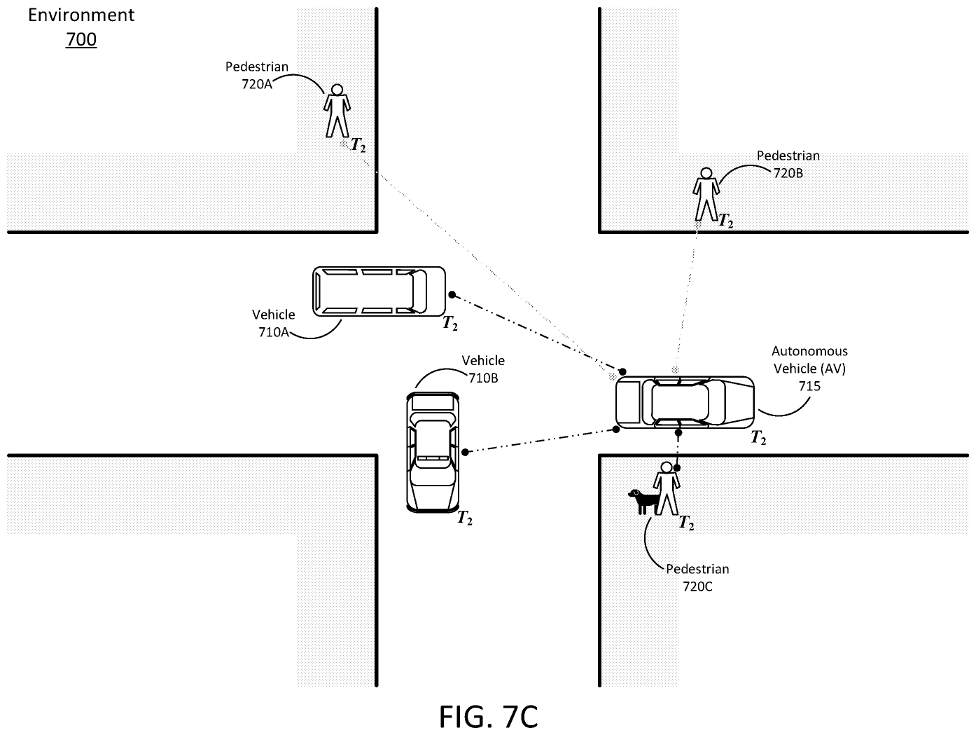

FIGS. 7A-7C show example embodiments for determining distance estimates for each actor, according to one embodiment. The examples of FIGS. 7A-7C show the same environment as FIG. 4 as the respective positions of the AV and each of the actors is “unrolled” to data for each of the times T₀-T₂ in this simple example. FIG. 7A shows the respective positions of the AV 715 and detected actors including vehicles 710A-B and pedestrians 720A-C.

The respective movement and trajectories of the AV 715 and detected actors are similar in FIGS. 7A-7C as shown in FIG. 4. For example, the AV 715 has a planned AV intent of approaching the intersection and turning right. Likewise, the pedestrians 720A-B are stationary, and each vehicle 710A-B and the pedestrian 720C are each moving towards the intersection. At the initial time T₀, the distance between each actor and the AV 715 may be estimated and added to the actor features 612 for the time T₀. The distance between the AV 715 and each actor may be calculated in one embodiment as an estimated Euclidian distance between the position of the AV 715 (or the nearest exterior of the AV) and respective actor's position at T₀. In some embodiments (e.g., for simplicity of calculation), the AV's position may be represented as a center of the AV 715, while in others, the distance may be measured as an estimate between each actor and the nearest external surface of the AV (e.g., to account for the actual surface shape of the AV 715 and its surface distances of the AV).

FIG. 7B shows the estimated position of the AV and each actor at the next time, time T₁. As discussed above, the position of the AV may be updated according to its intent, while the position of the respective actors at T₁ may be estimated based on the kinematics of each actor at the current time (alone and/or in combination with information from previous ticks of the perception stack). As shown in FIG. 7B, several of the actors have a reduced expected distance to the AV 715 at T₁, for example, as the vehicle 710A and 710B approach and/or enter the intersection. FIG. 7C similarly shows the predicted positions of the AV 715 and actors at time T₂. As shown in FIG. 7C, pedestrian 720C is predicted to have a significantly shorter distance to the AV 715, and vehicle 710A is predicted to also get significantly closer, while, for example, pedestrian 720A has an increased distance. In this example, the estimated positions of the various actors may be based on the detected kinematics and/or instantaneous movement detected in the sensor data for T₀, predicting the positions of the actors if they do not otherwise change movement trajectory. In this example, because the predicted movement of vehicle 710A may be increasingly close to the AV 715, the reduced distance may affect the predicted rank to encourage additional movement and prediction algorithms to be applied to determine the likely movement of the vehicle 710A.

Returning to FIG. 6, the actor features 612 (which may include the estimated actor distances) may then be provided to an actor embedding model 615 to generate the actor embedding 618. The actor features for each actor may be provided to the actor embedding model 615 to generate a respective actor embedding 618. Similarly, the AV features 600 are provided to an AV embedding model 605 to generate an AV embedding 608 describing the AV intent as an embedding. The AV embedding model 605 and actor embedding model 615 are computer models having respective parameters for generating the embeddings from the respective features. As discussed above, each embedding may describe the respective information as a vector of values. Each of the embedding models, such as the AV embedding model 605 and actor embedding model 615 may include a computer-trained model such as a MLP or a neural network including one or more layers having parameters (e.g., weights) for processing the input features to generate a respective embedding. The embedding models may include one or more fully-connected layers, and in various embodiments include two or three layers. The complexity (e.g., the number of nodes or number of layers, etc.) of the embedding models may be varied in different embodiments according to trainable prediction accuracy as well as execution time for the respective models. In one embodiment, the various embedding models are MLPs having two or more layers. In various embodiments, the model complexity may be suitable for execution by a linear processor (e.g., a CPU) rather than a specialized matrix or tensor processor, enabling relatively fast, inexpensive execution during the tick of the perception/planning stacks.

Rather than directly using the AV embedding 608 for actor importance prediction, in this example, the actor importance model generates a scene embedding 645 to describe the “scene” in which the AV operates, which in some embodiments may describe intended movement of the AV with respect to the overall set of actors in the environment. That is, the scene embedding 645 characterizes the general AV intent and objects in the scene as a whole. To predict individual actor importance, the scene embedding 645 may then be applied to each of the actor embeddings 618 to determine the relative ranking of the respective actor and the output actor importance ranking 660.

In one embodiment, the scene embedding 645 is generated by a scene embedding model 640, which may include multiple layers as discussed above with respect to the other embedding models. The scene embedding model 640 may receive, as inputs, the AV embedding 608 and a joint actor embedding 630. In some embodiments, the scene embedding model 640 may also receive one or more environmental features 620. In this example, the joint actor embedding 630 describes characteristics of the set of actor embeddings 618 as a whole. The number of actors (and hence number of actor embeddings 618) is variable, such that the joint actor embedding 630 may provide a single actor embedding 630 to represent the set of actor embeddings 618 for input to the scene embedding model 640. The various inputs to the scene embedding model 640 may be concatenated for input to the scene embedding model 640.

In one embodiment, the joint actor embedding 630 may be generated by combining the values of the actor embeddings 618, for example by summing each of the positions in the embedding (i.e., the values for each index of the vector across the actor embeddings). In one embodiment, the values of each position in the embedding are averaged across the set of actor embeddings 618. In general, because ranking of the actors is not yet known, the combination of the individual actor embeddings 618 to generate the joint actor embeddings 630 should be invariant to the sequence in which each actor embedding is added. As the joint actor embedding 630 represents the set of actor embeddings 618 and the AV embedding 608 represents the AV intent, the scene embedding model 640 generates a scene embedding 645 that generally represents the intended AV trajectory in conjunction with the set of actors within the environment.

The scene embedding model 640 may also receive one or more environmental features 620 that may describe aspects of the environment that may not be captured by the actors or AV intent. These environmental features 620 may include, for example, weather or other climate information, traffic signal or navigation rules (e.g., stop signs, current traffic signals, etc.), time of day (e.g., daybreak, noon, dusk, evening, etc.) and other characteristics that may affect actor movement or importance. These environmental features 620 may be provided, in addition to the AV embedding 608 and joint actor embedding 630, as inputs to the scene embedding model 640. In some embodiments, these inputs may be concatenated to form a single input feature set (e.g., a combined vector) for processing by the scene embedding model 640.

In general, different processing aspects (e.g., models) or data as shown in FIG. 6 are separately shown for convenience of illustration and explanation; these may be combined to a single component or separated into individual components in various embodiments. As such, data separately identified in FIG. 6 (such as joint actor embedding 630 or AV embedding 608) may be present as a data output of a processing step/model layer and immediately consumed by a subsequent process/layer without separately storing or saving such data. In the example of FIG. 6, the scene embedding model 640 is shown as a separate component from the AV embedding model 605. In other embodiments, the AV embedding model 605 may be functionally incorporated as separate layers of the scene embedding model 640, for example as a branch that processes the AV features 600 to generate a representation of the AV intent before layers that jointly process the AV intent along with the joint actor embedding 630. Similarly, the scene embedding model may include the processing for generating the joint actor embedding 630 based on the set of actor embeddings 618. As noted above, as the joint actor embedding 630 is invariant to the order of the actors, the joint actor embedding may be determined by a layer that accumulates/processes actor embeddings 618 from the actor embedding model 615 and proceeds to process the joint actor embedding 630 when all actor features have been processed to actor embeddings 618 and accounted for in the joint actor embedding 630.

Finally, using the scene embedding 645 to represent the overall scene, the actor-scene importance model 650 may process the actor embeddings (shown here as a list of actors x₁ to xₙ) to evaluate the relative importance of the actors with respect to the scene as represented in the scene embedding 645. In one embodiment, the actor-scene importance model 650 is also a multi-layer computer model, which may include one or more fully-connected layers. In one embodiment, the actor-scene importance model 650 is an MLP. Because the number of actors may be unknown and is variable, the actor-scene importance model may generate an importance score (e.g., an integer or real number) representing the expected importance of an actor with respect to the scene (as characterized by the respective embeddings). The actor-scene importance model 650 may be applied to each of the actors to generate an importance score 655 for each of the actors. For each actor, the actor-scene importance model 650 may receive the respective actor embedding and the scene embedding (e.g., as a pair) and output the actor importance score for that actor. For the scene as a whole, the scene embedding may thus be constant, while the individual actor embeddings are changed to determine the respective actor importance score 655 of the actor with respect to this scene. The actor importance scores 655 may then be ordered accordingly (e.g., from highest to lowest, or lowest to highest), and the position of each actor's importance score in the order may then be used to define the actor importance ranking 660. As the joint actor embedding 630 may combine any number of actor embeddings and the actor-scene importance model 650 may be applied to individual actor embeddings 618, the overall architecture may effectively evaluate any number of actors in the environment.

The architecture of the actor importance model in various embodiments may also differ relative to FIG. 6. For example, in some embodiments the scene embedding model 640 may not use any actor-based information (e.g., omitting the joint actor embedding 630), or the actor-scene importance model 650 may use the AV intent (e.g., as an AV embedding 608) without further processing it to account for further scene information (e.g., environmental features or actor information).

The various parameters of the actor importance model (e.g., parameters of the AV embedding model 605, actor embedding model 615, scene embedding model 640, and actor-scene importance model 650) may be trained with a set of training data to learn parameters that effectively predict ranking with respect to a training ranking of the data in the training data. For each training instance in the training data, a number of actors and AV intent is used as input and the actors may be labeled with a training ranking for the model to learn towards. The predicted ranking output from the model is compared with the training ranking of the training instance and used to determine a loss function for modifying the parameters of the model to reduce the loss function.

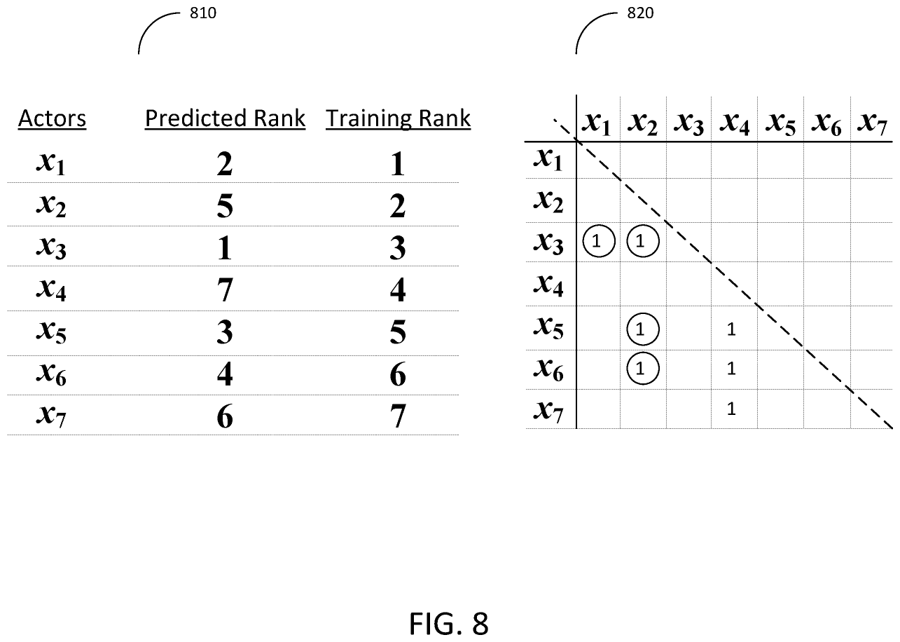

FIG. 8 shows an example of a training loss (e.g., a loss function) for an example training data instance, according to one embodiment. In various embodiments, the loss function is based on the relative order of the actors in the training data. As such, the loss function may consider whether the actor is above or below other actors and/or a threshold consistent with the training ranking. This relative ranking may thus account for the placement of actors with respect to one another. Ranking table 810 provides an example of the training ranking and predicted ranking of a training instance having seven actors labeled x₁-x₇. In this example, the actors are labeled, for convenience, with respect to their ranking in the training rank, such that x₁ is ranked first, x₂ is ranked second, and so forth. The predicted rank from the actor importance model is also provided, showing predicted ranks from the model. For example, x₁ is predicted as rank 2, x₂ is predicted as rank 5, and so forth. While the absolute ranking may also be evaluated, the relative loss may consider whether each of the actors is properly ranked with respect to others of the actors. For example, the relative ordering may be based on a pairwise comparison of the predicted rankings relative to the training ranking.

A loss matrix 820 illustrates an example loss according to one embodiment. In this embodiment, the loss function is a pairwise loss, such that the loss is considered between pairs of the actors, for example the pair (x₁, x₂) or (x₃, x₇). The example matrix is illustrated as a diagonal matrix, such that the lower left portion of the matrix may show attributable loss function, if any, to each pair. In this example, the loss function for a pair has a loss of “1” when the pair is improperly ordered (e.g., the pairwise ranking of the actors in the predicted rank are not the same as the training rank) and a loss of zero otherwise. The mis-ordered pairs are shown in the loss matrix 820 as having a value of 1. To perform training of the model parameters, the model may learn parameters to reduce the loss function, that is, the number of actors which are mis-ordered in the predicted rank relative to the training rank. This loss formulation may provide superior results, particularly given the dynamic number of actors within a given scene. For loss functions which focus on absolute ranking of actors, a given actor's correct rank may vary significantly depending on the environment and the number of actors in the environment, even if nothing else about the environment changes. For example, the same actor, appearing in the same scene with the same AV intent, may have a rank of 2 when 10 actors are detected, and a rank of 12 when 100 actors are detected. Loss functions which attempt to reconcile the values of “2” and “12” directly may struggle to effectively learn parameters for the actor. However, in the relative ranking, the parameters may learn to generate an importance score for the actor that permits effective comparison with the importance score of other actors, permitting effective dynamic ranking of different sets of actors.

In further examples, the loss may also be affected by a threshold penalty. In many applications, due to the limited resources in the AV, a limited number of actors may be further processed as also discussed above. For example, a maximum number of actors may be provided for further classification or motion prediction in a tick. Other actors may be provided no further analysis or may be provided for a more limited analysis. As such, removal of actors that should have been included in the actors provided for further processing may negatively impact these further processes.

In some embodiments, a threshold penalty is used to modify a training loss with respect to a threshold. The training loss may be increased, for example, for actors predicted to be below the threshold, while having a training rank above the threshold. In other examples, the training loss may be modified based on whether the actors in the pair are above or below the threshold. In some examples, as actors above the threshold may generally be provided for further processing, in some examples, when both actors (in a pairwise loss) are above or below the threshold, the loss may be reduced, e.g., as the ranking error would not have affected which actors pass or do not pass the threshold.

As another example, the threshold penalty may be an added error for actors that have a training rank above the threshold and that are predicted to be below the threshold. In this example, the threshold penalty may be proportional to a rank difference between the predicted rank (i.e., below the threshold) and the threshold rank. For example, a training (true) rank 5 predicted to be rank 20 with a penalty threshold of 12 has a predicted rank difference of 8 with the penalty threshold, yielding gets a threshold penalty of k*8 for a threshold of 12, where k is a proportionality coefficient. The threshold penalty may be added to the ordering loss for the actor. This penalty may thus accentuate the error for actors that should be included above the threshold and due to the increased error encourage training that learns parameters to move the actors above the threshold faster.

In the example shown in FIG. 8, the threshold is a rank of 5. In this example, the training error for pairs above the threshold are designated with a circle in the loss matrix 820. In each of these examples, such as the pair (x₂, x₃), while the relative order was incorrect in the predicted rank, each actor in the pair was still above the threshold. In some embodiments, these values may be reduced to either contribute less or nothing to the training loss. As shown in the loss matrix 820, this may emphasize the training loss for the erroneously low predicted rank of actor x₄ and its pairwise error with x₅, x₆, and x₇, encouraging parameters to be modified to such that x₄ rises relative to these other actors. Because actors may have individually-calculated importance scores and may be compared on a relative ordering basis, the parameters may be modified in training to effectively and individually modify the resulting values, providing for effective convex training of the actor ranking. In addition, this training loss may effectively address dynamic numbers of actors while also not requiring synthetic training data generation or generation of negative data samples.

In some embodiments, the training ranking may be based on manual or semi-manual review (e.g., by a human). In additional embodiments, the training ranking may be automatically generated based on how further processes (such as further actor perception and prediction 550 and motion planning 560 discussed above) may process the actor importance rankings. For example, in various embodiments the loss function may reduce or eliminate the loss for predicted ranking error of actors ranked higher (e.g., less important) than a threshold set based on the number of actors used in further processes as just discussed. Likewise, the further processes may also be used to automatically label training data for training data based on the effect of the actor on motion planning. For example, the motion planning may be performed with the complete set of actors and with a counterfactual in which each actor is removed from consideration in motion planning. The change in planned motion between the two motion planning scenarios may then implicitly describe the relative importance of the actor; the actors with a more significant affect (when included vs. not included) may be considered more important to the planning process and used to automatically label training data with a training ranking accordingly.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### Select Examples

Various embodiments of claimable subject matter includes the following examples.
Example 1 provides a method for identifying a set of actors in an environment of a vehicle, e.g., an autonomous vehicle (AV), and associated actor features for each actor; identifying one or more intent features describing planned movement of the vehicle; applying an attention model to the agent features and the one or more intent features, the attention model outputting a predicted ranking of the set of actors based on a set of parameters of the attention model; and training the parameters of the attention model based at least in part on a training loss determined by a relative ordering of the predicted ranking compared to a training ranking of the set of detected actors.
Example 2 provides for the method of example 1, wherein the training loss includes a pairwise loss based on the relative ordering of a first actor and a second actor in the predicted ranking relative to the training ranking.
Example 3 provides for the method of examples 1-2, wherein the training loss reduces the training loss for actors in the predicted ranking based on a threshold ranking of the training ranking.
Example 4 provides for the method of any of examples 1-3, wherein the actor features and one or more intent features include features at a plurality of times.
Example 5 provides for the method of any of examples 1-4, wherein the attention model is configured to: determine a set of agent embeddings corresponding to the set of detected agents based on respective agent features for each agent; determine a scene embedding determined based on the one or more intent features; and determine the respective rank of an agent based on the respective agent embedding and the scene embedding.
Example 6 provides for the method of example 5, wherein the scene embedding is further based on a joint actor embedding determined based on a combination of the set of actor embeddings.
Example 7 provides for the method of example 5, wherein the parameters of the attention model include parameters for determining the set of agent embeddings and the scene embedding.
Example 8 provides a system including identifying a set of actors in an environment of a vehicle, e.g., an AV, and associated actor features for each actor; identifying one or more intent features describing planned movement of the vehicle; applying an attention model to the agent features and the one or more intent features, the attention model outputting a predicted ranking of the set of actors based on a set of parameters of the attention model; and training the parameters of the attention model based at least in part on a training loss determined by a relative ordering of the predicted ranking compared to a training ranking of the set of detected actors.
Example 9 provides for the system of example 8, wherein the training loss includes a pairwise loss based on the relative ordering of a first actor and a second actor in the predicted ranking relative to the training ranking.
Example 10 provides for the system of examples 8-9, wherein the training loss reduces the training loss for actors in the predicted ranking based on a threshold ranking of the training ranking.
Example 11 provides for the system of any of examples 8-10, wherein the actor features and one or more intent features include features at a plurality of times.
Example 12 provides for the system of any of examples 8-11, wherein the attention model is configured to: determine a set of agent embeddings corresponding to the set of detected agents based on respective agent features for each agent; determine a scene embedding determined based on the one or more intent features; and determine the respective rank of an agent based on the respective agent embedding and the scene embedding.
Example 13 provides for the system of example 12, wherein the scene embedding is further based on a joint actor embedding determined based on a combination of the set of actor embeddings.
Example 14 provides for the system of example 12, wherein the parameters of the attention model include parameters for determining the set of agent embeddings and the scene embedding.
Example 15 provides a non-transitory computer-readable medium containing instructions executable by a processor for: identifying a set of actors in an environment of a vehicle, e.g., an autonomous vehicle (AV), and associated actor features for each actor; identifying one or more intent features describing planned movement of the vehicle; applying an attention model to the agent features and the one or more intent features, the attention model outputting a predicted ranking of the set of actors based on a set of parameters of the attention model; and training the parameters of the attention model based at least in part on a training loss determined by a relative ordering of the predicted ranking compared to a training ranking of the set of detected actors.
Example 16 provides for the computer-readable medium of example 15, wherein the training loss includes a pairwise loss based on the relative ordering of a first actor and a second actor in the predicted ranking relative to the training ranking.
Example 17 provides for the computer-readable medium of examples 15-16, wherein the training loss reduces the training loss for actors in the predicted ranking based on a threshold ranking of the training ranking.
Example 18 provides for the computer-readable medium of any of examples 15-17, wherein the actor features and one or more intent features include features at a plurality of times.
Example 19 provides for the computer-readable medium of any of examples 15-18, wherein the attention model is configured to: determine a set of agent embeddings corresponding to the set of detected agents based on respective agent features for each agent; determine a scene embedding determined based on the one or more intent features; and determine the respective rank of an agent based on the respective agent embedding and the scene embedding.
Example 20 provides for the computer-readable medium of example 19, wherein the scene embedding is further based on a joint actor embedding determined based on a combination of the set of actor embeddings.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

What is claimed is:

1. A method comprising:
identifying a set of actors in an environment of a vehicle and associated actor features for each actor;
identifying one or more intent features describing planned movement of the vehicle;
applying an attention model to the actor features and the one or more intent features, the attention model outputting a predicted ranking of the set of actors based on a set of parameters of the attention model; and
training the parameters of the attention model based at least in part on a training loss determined by a relative ordering of the predicted ranking compared to a training ranking of the set of detected actors.

2. The method of claim 1, wherein the training loss includes a pairwise loss based on the relative ordering of a first actor and a second actor in the predicted ranking relative to the training ranking.

3. The method of claim 1, wherein the training loss reduces the training loss for actors in the predicted ranking based on a threshold ranking of the training ranking.

4. The method of claim 1, wherein the actor features and one or more intent features include features at a plurality of times.

5. The method of claim 1, wherein the attention model is configured to:
determine a set of agent embeddings corresponding to the set of detected agents based on respective agent features for each agent;
determine a scene embedding determined based on the one or more intent features; and
determine the respective rank of an agent based on the respective agent embedding and the scene embedding.

6. The method of claim 5, wherein the scene embedding is further based on a joint actor embedding determined based on a combination of the set of actor embeddings.

7. The method of claim 5, wherein the parameters of the attention model include parameters for determining the set of agent embeddings and the scene embedding.

8. A system, comprising:
a processor; and
a non-transitory computer-readable storage medium containing instructions for execution by the processor for:
identifying a set of actors in an environment of a vehicle and associated actor features for each actor;
identifying one or more intent features describing planned movement of the vehicle;
applying an attention model to the actor features and the one or more intent features, the attention model outputting a predicted ranking of the set of actors based on a set of parameters of the attention model; and
training the parameters of the attention model based at least in part on a training loss determined by a relative ordering of the predicted ranking compared to a training ranking of the set of detected actors.

9. The system of claim 8, wherein the training loss includes a pairwise loss based on the relative ordering of a first actor and a second actor in the predicted ranking relative to the training ranking.

10. The system of claim 8, wherein the training loss reduces the training loss for actors in the predicted ranking based on a threshold ranking of the training ranking.

11. The system of claim 8, wherein the actor features and one or more intent features include features at a plurality of times.

12. The system of claim 8, wherein the attention model is configured to:
determine a set of agent embeddings corresponding to the set of detected agents based on respective agent features for each agent;
determine a scene embedding determined based on the one or more intent features; and
determine the respective rank of an agent based on the respective agent embedding and the scene embedding.

13. The system of claim 12, wherein the scene embedding is further based on a joint actor embedding determined based on a combination of the set of actor embeddings.

14. The system of claim 12, wherein the parameters of the attention model include parameters for determining the set of agent embeddings and the scene embedding.

15. A non-transitory computer-readable medium containing instructions executable by a processor for:
identifying a set of actors in an environment of a vehicle and associated actor features for each actor;
identifying one or more intent features describing planned movement of the vehicle;
applying an attention model to the actor features and the one or more intent features, the attention model outputting a predicted ranking of the set of actors based on a set of parameters of the attention model; and
training the parameters of the attention model based at least in part on a training loss determined by a relative ordering of the predicted ranking compared to a training ranking of the set of detected actors.

16. The computer-readable medium of claim 15, wherein the training loss includes a pairwise loss based on the relative ordering of a first actor and a second actor in the predicted ranking relative to the training ranking.

17. The computer-readable medium of claim 15, wherein the training loss reduces the training loss for actors in the predicted ranking based on a threshold ranking of the training ranking.

18. The computer-readable medium of claim 15, wherein the actor features and one or more intent features include features at a plurality of times.

19. The computer-readable medium of claim 15, wherein the attention model is configured to:
determine a set of agent embeddings corresponding to the set of detected agents based on respective agent features for each agent;
determine a scene embedding determined based on the one or more intent features; and
determine the respective rank of an agent based on the respective agent embedding and the scene embedding.

20. The computer-readable medium of claim 19, wherein the scene embedding is further based on a joint actor embedding determined based on a combination of the set of actor embeddings.
